(19) United States
(12) Patent Application Publication
(10) Pub. No.: US 2014/0355504 A1
(43) Pub. Date: Dec. 4, 2014

(54) Handling a State of a Device

(71) Applicant: Nokia Solutions and Networks Oy, Espoo (FI)

(72) Inventors: Lei Du, Beijing (CN); Benoist Pierre Sebire, Tokyo (JP); Chunli Wu, Beijing (CN); Woonhee Hwang, Espoo (FI)

(21) Appl. No.: 14/361,350

(22) PCT Filed: Nov. 30, 2011
(86) PCT No.: PCT/EP2011/071385

§ 371 Date: Aug. 20, 2014

(51) Int. Cl. H04W 28/02; H04W 56/00; H04W 76/04; H04W 52/02; H04W 72/04

(52) U.S. Cl. CPC H04W 28/0221; H04W 52/0216; H04W 72/0446; H04W 76/048; H04W 56/001
USPC 370/311

(57) ABSTRACT

Method and apparatuses for handling transition of a connected device to an unsynchronised state are disclosed. In accordance with a method a trigger for move from a synchronised state is determined where after a control channel for the synchronised state is released and a move to the unsynchronised state is performed while remaining connected based on a discontinuous reception configuration defined for the unsynchronised state. The discontinuous reception configuration can be sent to the device. Control information can be sent to the device according to the discontinuous reception configuration.

This disclosure relates to handling of states in communications between at least two nodes, and more particularly to move of a device to an unsynchronised state.

A communication system is a facility that enables communication sessions between two or more nodes such as fixed or mobile devices capable of wireless communications, access nodes such as base stations, servers and so on. A communication system and compatible communicating entities typically operate in accordance with a given standard or specification which sets out what the various entities associated with the system are permitted to do and how that should be achieved. For example, the standards, specifications and related protocols can define the manner how various nodes shall communicate, how various aspects of the communications shall be implemented and how the nodes shall be configured.

Communications between nodes can be carried on wireless carriers. Examples of wireless systems include public land mobile networks (PLMN) such as cellular networks, satellite based communication systems and different local wireless system, for example wireless local area networks (WLAN)) and/or WiMax (Worldwide Interoperability for Microwave Access). An example of wireless systems is an architecture based on standards by the 3rd Generation Partnership Project (3GPP). Recent development of the 3GPP architecture is the long-term evolution (LTE) of the Universal Mobile Telecommunications System (UMTS) radio-access technology.

A user can access a communication system by means of an appropriate communication device. A communication device of a user is often referred to as user equipment (UE) or terminal. A communication device is provided with an appropriate signal receiving and transmitting arrangement for enabling communications with other parties. In wireless systems a communication device provides a transceiver station that can communicate over an air interface. The communication device can transmit and/or receive communications with other nodes such as base stations, other communications devices and so on.

Service providers are facing increasing demand for what is known as always-on connectivity. In the context of providing always-on connectivity, mechanisms are needed at the radio access network (RAN) level that enhance the ability to handle diverse traffic profiles. Under diverse traffic loads, it may be beneficial to allow for trade-offs to be achieved when balancing needs such as network efficiency, terminal battery life, signalling overheads, user experience and/or system performance. For example, in LTE a user equipment (UE) alternates between idle and connected modes depending on whether the connection is established or not. In LTE specifications these modes are referred to as RRC_IDLE and RRC_CONNECTED. When a device such as mobile user equipment is in a connected mode, it transits from a synchronised state (LTE: SYNC) to a unsynchronised state (LTE: OUT-OF-SYNC) upon expiry of a time alignment timer (LTE: timeAlignmentTimer) The time alignment timer (TAT) is a timer function controlling when a user equipment can be considered being in uplink time aligned state. In LTE synchronised state is understood as a period when a time alignment timer (TAT) is running. Unsynchronised/OUT-OF-SYNC state is understood as a period when the time alignment timer is not running. The time alignment timer is configured by radio resource control (RRC) layer via either system information block (SIB) or dedicated message. In LTE the duration of the timer is configured by the eNodeB of the network. Time alignment timer (TAT) is restarted each time a timing advance command is received from the network.

When a LTE user equipment (UE) is in SYNC state (i.e. when having valid timing advance (TA) i.e. time alignment timer is running), a dedicated physical uplink control channel (PUCCH) is reserved for the user equipment. As long as the time alignment timer is running, the user equipment can consider its uplink as synchronized and can transmit directly using resources of the Physical Uplink Control Channel (PUCCH) or Physical Uplink Shared Channel (PUSCH) when grants are provided. If the timer expires, the UE must use a Random Access Channel (RACH) to reacquire uplink synchronization before any uplink transmissions can be made. Upon uplink (UL) data arrival the user equipment could initiate scheduling request (SR) immediately over PUCCH. However, if a user equipment is in OUT-OF-SYNC state, it has released its PUCCH resource and therefore a random access procedure is needed for the user equipment to request resources, regardless how quickly the resources are needed.

A user equipment (UE) needs to keep the PUCCH in order to stay in SYNC state, and provide measurements, reporting and other required actions. Thus, whilst being connected and in the synchronised state, the user equipment may need to take various actions such as perform measurements such as radio resource management (RRM) measurement, provide Channel Quality Indicator/Precoding Matrix Index (CQI/PMI) report periodically and so forth. These actions can consume substantial amount of power compared to remaining in the OUT-OF-SYNC state. In addition, if a large amount of user equipments that are temporarily inactive nevertheless stay in connected SYNC mode, for example to keep their chat applications, voice over internet protocol (VoIP) applications and similar services online, this may exhaust available PUCCH resources and therefore impact the access of other devices which may have ongoing services. This may become a particular problem due to the increased use of smart phones.

In accordance with an aspect there is provided a method for handling transition of a connected device to an unsynchronised state, comprising determining a trigger for move from a synchronised state, releasing a control channel for the synchronised state, and moving to the unsynchronised state while remaining connected based on a discontinuous reception configuration defined for the unsynchronised state.

In accordance with an aspect there is provided a method for handling a device in an unsynchronised state, comprising sending to the device a discontinuous reception configuration to be used by a device when in the unsynchronised state while remaining connected, and sending control information to the device according to the discontinuous reception configuration defined for the unsynchronised state.

In accordance with an aspect there is provided an apparatus comprising at least one processor, and at least one memory including computer program code, wherein the at least one memory and the computer program code are configured, with the at least one processor, to determine a trigger for move from a synchronised state, release a control channel for the synchronised state, and move the device to an unsynchronised state while remaining connected based on a discontinuous reception configuration defined for the unsynchronised state.

In accordance with an aspect there is provided an apparatus comprising at least one processor, and at least one memory including computer program code, wherein the at least one memory and the computer program code are configured, with the at least one processor, to cause sending to a device a discontinuous reception configuration to be used when the device is in an unsynchronised state while remaining connected, and cause sending of control information to the device according to the discontinuous reception configuration defined for the unsynchronised state.

In accordance with another aspect there is provided a method for handling transition to an unsynchronised state, comprising sending to a network a request for transition of a device from a synchronised state to the unsynchronised state, receiving from the network a command to move to the unsynchronised state, stopping a time alignment timer, releasing a control channel for the synchronised state, and remaining connected to the network based on a discontinuous reception configuration defined for the unsynchronised state.

In accordance with a yet another aspect there is provided method for handling transition to an unsynchronised state, comprising receiving a request for transition of a device from a synchronised state to the unsynchronised state, sending to the device a command to move to the unsynchronised state thereby causing the device to stop a time alignment timer and release a control channel for the synchronised state, and maintaining the device in connected state based on a discontinuous reception configuration defined for the unsynchronised state.

In accordance with an aspect there is provided an apparatus comprising at least one processor, and at least one memory including computer program code, wherein the at least one memory and the computer program code are configured, with the at least one processor, to cause sending to a network a request for transition of a device from a synchronised state to the unsynchronised state, receive from the network a command to move to the unsynchronised state, stop a time alignment timer, release a control channel for the synchronised state, and maintain the device connected to the network based on a discontinuous reception configuration defined for the unsynchronised state.

In accordance with an aspect there is provided an apparatus comprising at least one processor, and at least one memory including computer program code, wherein the at least one memory and the computer program code are configured, with the at least one processor, to receive a request for transition of a device from a synchronised state to the unsynchronised state, sending to the device a command to move to the unsynchronised state, thereby causing the device to stop a time alignment timer and release a control channel for the synchronised state, and maintain the device in connected state based on a discontinuous reception configuration defined for the unsynchronised state.

In accordance with an embodiment move from synchronised state to unsynchronised state is triggered by determined expiry of a time alignment timer.

A communication device may be configured based on radio resource control signalling or at least one broadcast message. The device may perform at least one of a measurement, reporting and monitoring of a physical downlink control channel in accordance with a discontinuous reception configuration.

A long discontinuous reception pattern or an idle state discontinuous reception pattern may be used as a default reception pattern when the device is in the unsynchronised state.

Information may be communicated from the device to the network before the device moves to the unsynchronised state, the information being indicative of a discontinuous reception pattern to be used by the device when in the unsynchronised state.

A time alignment timer expiry may be determined releasing resources associated with a physical uplink control channel may be released before ordinary expiry of the time alignment timer.

It can be determined if the device will be inactive for at least a period. In response to such determining, a request for a move of the device to the unsynchronised state may be communicated.

A node such as a network controller or a communication device can be configured to operate in accordance with the various embodiments.

A computer program comprising program code means adapted to perform the method may also be provided.

It should be appreciated that any feature of any aspect may be combined with any other feature of any other aspect.

Embodiments will now be described in further detail, by way of example only, with reference to the following examples and accompanying drawings, in which:

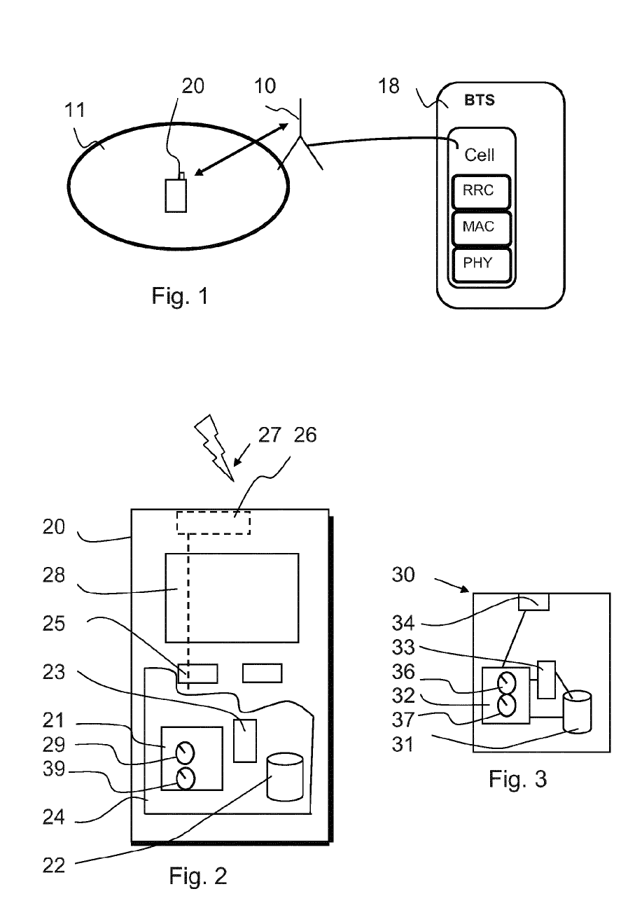

FIG. 1 shows a schematic diagram of an access system according to some embodiments;

FIG. 2 shows a schematic diagram of a mobile communication device according to some embodiments;

FIG. 3 shows a schematic diagram of a control apparatus according to some embodiments; and

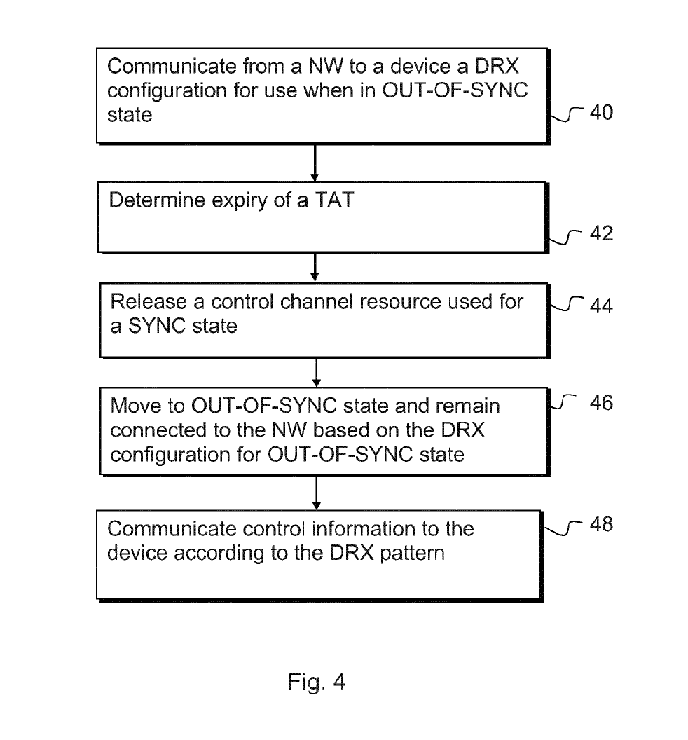

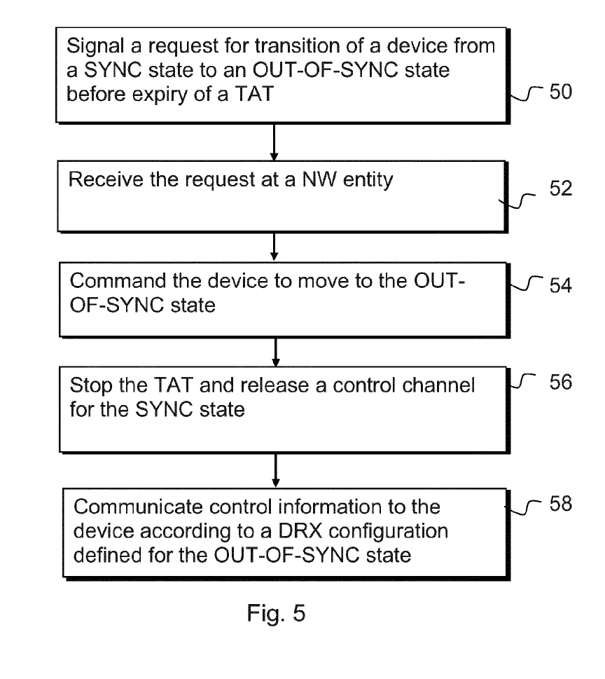

FIGS. 4 and 5 are flowcharts according to certain embodiments.

In the following certain exemplifying embodiments are explained with reference to a wireless or mobile communication system serving mobile communication devices. Before explaining in detail the exemplifying embodiments, certain general principles of wireless communication and wireless access and related nodes are briefly explained with reference to FIGS. 1 to 3.

A communication device 20 can typically be provided wireless access via at least one base station or similar wireless transmitter and/or receiver node of an access system. In FIG. 1 a base station 10 is shown, the base station providing at least one radio cell 11. Each communication device and base station may have one or more radio channels open at the same time and may send signals to and/or receive signals from more than one source. Possible cells include those known as macro cells, pico cells and femto cells. It is noted that any number of communication devices and base stations and cells can be provided in a communication system. A base station is typically controlled by at least one controller apparatus so as to enable operation thereof and management of mobile communication devices in communication with the base station. FIG. 1 shows control apparatus 18 for control of the base station 10 and thus the cell or cells provided by the base station.

A non-limiting example of communication system architectures is the long-term evolution (LTE) of the Universal Mobile Telecommunications System (UMTS) that is being standardized by the 3rd Generation Partnership Project (3GPP). A further development of the LTE is referred to as LTE-Advanced. The LTE employs a mobile architecture known as the Evolved Universal Terrestrial Radio Access Network (E-UTRAN). Base stations or base station systems of such architectures are known as evolved or enhanced Node Bs (eNBs). An eNB may provide E-UTRAN features for cells such as user plane Radio Link Control/Medium Access Control/Physical layer protocols (RLC/MAC/PHY) and control plane Radio Resource Control (RRC) protocol terminations towards the communication devices. Other examples of radio access include those provided by base stations of systems that are based on technologies such as wireless local area network (WLAN) and/or WiMax (Worldwide Interoperability for Microwave Access).

A possible mobile device for communication with a base station will now be described in more detail with reference to FIG. 2 showing a schematic, partially sectioned view of a device 20 for mobile communications. Such a device is often referred to as user equipment (UE) or terminal. An appropriate mobile device may be provided by any device capable of sending radio signals to and/or receiving radio signals from at least one other node. The mobile device may receive signals over an air interface 27 via appropriate apparatus for receiving and may transmit signals via appropriate apparatus for transmitting radio signals. In FIG. 2 transceiver apparatus is designated schematically by block 26. The transceiver apparatus 26 may be provided for example by means of a radio part and associated antenna arrangement. The antenna arrangement may be arranged internally or externally to the device.

Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. A user may also be provided broadcast or multicast data. Non-limiting examples of the content include downloads, television and radio programs, videos, advertisements, various alerts and other information.

A mobile communication device is also provided with at least one data processing entity 21, at least one memory 22 and other possible components 23 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 24. The control apparatus may provide various timer functions. For example, a time alignment timer 29 for controlling transition between synchronised and unsynchronised states may be provided. Another timer function 39 may be provided for the purposes of discontinuous reception (DRX). Operation of such timer functions will be explained below in more detail in the relevant context.

The user may control the operation of the mobile device by means of a suitable user interface such as key pad 25, voice commands, touch sensitive screen or pad, combinations thereof or the like. A display 28, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling one or more stations providing cells. The control apparatus may be provided form example in association with an eNB. It is noted that in some embodiments each base station comprises a separate control apparatus that may communicate control data with each other. The control apparatus 30 can be arranged to provide control on communications in the service area of the system. The control apparatus 30 can be configured to provide control functions in association with various states of the device by means of data processing facility in accordance with certain embodiments described below. For this purpose the control apparatus comprises at least one memory 31, at least one data processing unit 32, 33 and an input/output interface 34. Via the interface the control apparatus can be coupled to a receiver and a transmitter of the base station. The control apparatus can also be interconnected with other control entities. Timer functions can also be provided. A network control element, e.g. an eNB, may need to maintain a time alignment timer 36. A DRX timer function 37 is provided so that the network element knows exactly when a connected device goes to sleep in order to send control information, e.g. a physical downlink control channel (PDCCH) during an active period. The control apparatus can be configured to execute an appropriate software code to provide the control functions. It shall be appreciated that similar component can be provided in a control apparatus provided elsewhere in the system and that the control apparatus and functions may be distributed between a plurality of control units.

A wireless communication device, such as a mobile station or a base station, can be provided with a Multiple Input/Multiple Output (MIMO) antenna system. MIMO arrangements as such are known. MIMO systems use multiple antennas at the transmitter and receiver along with advanced digital signal processing to improve link quality and capacity.

The following describes certain exemplifying embodiments how to handle a transition between synchronised and unsynchronised states and/or how to optimise use of these states. In the embodiments a device that is moved from synchronised state to unsynchronised state can remain connected with the network such that it is enabled to periodically listen to a control channel by the network in accordance with a reception pattern defined for the unsynchronised state. Control in this regard can be provided for example to obtain savings in view of physical uplink control channel (PUCCH) resource usage and/or power consumption. For always-on applications, such as those known as smart phone applications, unsynchronised or out-of-sync state might become a relatively often used state for a device in a power saving state. A move to an unsynchronised state may also be used to avoid a need for unnecessary transitions between idle and connected states, thus providing savings in signalling overhead in this regard.

Periodical reception of control information can be provided by means of discontinuous reception (DRX). Discontinuous reception allows a device such as a user equipment to periodically switch off its receiver for some time before it has to listen again to a control channel to see if there is any transmission for the device. On and off times can be configured dynamically down to the sub-frame level (1 ms) depending on the activity of the device. An expiry value for a DRX timer (e.g. timer 39 of FIG. 2) that starts running after each data block has been sent can be defined by a network entity when it configures DRX for a device. The DRX timer is restarted when new data is received, thus preventing the device entering DRX mode.

DRX may be operated in long or short cycles/modes when both long and short DRX cycles are configured. Typically transitions between long and short DRX schemes can be trigged by an appropriate control element in the network (e.g. by eNB) or can be timer driven. In the short DRX mode a device will go to sleep and wake up in a relatively short pattern. If data comes in there is then only a short latency in delivery because the device only sleeps for relatively short periods. The short DRX cycle mode can have a configurable timer attached, e.g. a drxShortCycleTimer, and once it expires, if no data is received during a drxShortCycletimer period, the device can enter a long DRX cycle where the inactivity period is longer. During each long DRX cycle a radio frequency (RF) modem of the device is turned on for a few consecutive subframes to listen to at least one relevant control channel. When data activity is detected in downlink or uplink activity is resumed and the short DRX cycle can be triggered for the device, increasing the responsiveness and connectivity before switching back to the long DRX cycle. The following presents ways to use the DRX and various possible DRX patterns in association with the unsynchronised state in accordance with certain embodiments.

An embodiment is shown in the flowchart of FIG. 4. According to this embodiment a network controller apparatus, for example an eNB, determines and sends at 40 to the device a discontinuous reception configuration to be used by the device subsequent to determination by the device that it is in unsynchronized state while remaining connected to the network. A condition triggering the determination can be expiry of a synchronization timer, for example the time alignment timer (TAT) 29 of FIG. 2. The determined expiry can take place prematurely to an ordinary expiry of the timer. The premature expiry may be determined in response to a command from the network, as will be explained below. The determined expiry may also take place when the timer expires in the ordinary manner.

Thus the device may at 42 determine expiry of a time alignment timer (TAT) thereof. In response thereto the device can then at 44 release a control channel for the synchronised state and move to unsynchronized state at 46. Instead of dropping the connection the device remains connected to the network based on a discontinuous reception configuration defined for the unsynchronised state. Since the device is still listening periodically a control channel by the network controller, control information can be sent at 48 to the device according to the discontinuous reception configuration to maintain the device in connected state.

It is noted that steps 40, 42, 44 and 46 can be performed by both the device and network control apparatus so that resources can also be released on the network side and so that the network knows the exact timing when the device is listening in order to establish possible communications.

In accordance with an embodiment shown by flowchart of FIG. 5, transition to unsynchronised state can be handled as follows. A device can determine that it is unnecessarily in synchronised state, i.e. that the time alignment timer (TAT) thereof is running although no active data communications is taking place or predicted for a certain period. In current operation a device such as a user equipment has to wait until expiry of the time alignment timer before it can enter the OUT-OF-SYNC state. In case the device is able determine that there is no data activity for a certain time period such waiting would be unnecessary and waste resources and power.

In response to determination that the time alignment timer is unnecessarily running the device can sent at 50 a request for transition thereof from synchronised state to unsynchronised state before expiry of the time alignment timer. A network element receives the request at 52. If the request is accepted, it sends at 54 to the device a command to move to unsynchronised state. Upon receipt of the command at 56 the device stops the time alignment timer and releases control channel resources for the synchronised state. As shown by block 58, the device nevertheless remains in connected state based on a discontinuous reception configuration defined for the unsynchronised state. A DRX pattern can be received from the network, as discussed above.

Discontinuous reception (DRX) can be configured per device. In accordance for example with the current LTE specifications a user equipment can follow the same DRX pattern or transit between short and long DRX cycle based on a timer, typically a drxShortCycleTimer, regardless whether it is in the synchronised or unsynchronised state. Instead of this, in accordance with an embodiment a device can be configured to use a different or predefined out-of-sync DRX configuration when in unsynchronised state. Considering that only some keep-alive messages are expected to be received relatively infrequently during the unsynchronised state, the device does not necessarily need to wake up frequently to monitor a control channel, e.g. a PDCCH

For example, an LTE eNB can configure an additional DRX pattern for use by a user equipment staying in unsynchronised state. The configuration can be provided via RRC signalling or broadcast messages. A user equipment can follow an indicated DRX cycle for measurement and/or physical downlink control channel (PDCCH) monitoring when in unsynchronised/OUT-OF-SYNC state when time alignment timer (TAT) is not running. Long DRX pattern can be used as a default DRX pattern when a time alignment timer expires. According to an alternative a DRX pattern that the UE uses in idle mode is used as a default DRX pattern when the time alignment timer expires.

In accordance with an embodiment a device can indicate to the network whether it uses short or long DRX pattern. Similarly, an indication of any other DRX pattern used by the device may be sent. This indication may be provided immediately before the device moves to unsynchronised/OUT-OF-SYNC state.

Flexible transition from synchronised/SYNC state to unsynchronised/OUT-OF-SYNC state may be allowed for a device. A message can be sent from the device to initiate the transition. For example, a device such as an user equipment (UE) can generate a media access control (MAC) message to request transition to unsynchronised/OUT-OF-SYNC state to release resource such as physical uplink control channel (PUCCH) and so on before the ordinarily scheduled expiry of the time alignment timer. Upon detecting the request, controlling network element may send a MAC command to move the UE to unsynchronised/OUT-OF-SYNC state and stop the time alignment timer.

Embodiments may provide lower power consumption due to staying longer in unsynchronised state and/or due to longer sleeping time in unsynchronised state if the long DRX pattern is used. More efficient resource usage may be achieved by having more devices to enter the unsynchronised state and thus release unnecessary physical control channel, e.g. PUCCH, resources. More devices may also be kept in connected mode and thus savings in idle-connected transition signalling may be achieved. Overall it is expected that flexible switching between synchronised and unsynchronised states can be used to increase control channel usage efficiency and decrease the power consumption. It is expected that the unsynchronised state becomes a relatively often used state for a device in power saving state while signalling for idle to connected mode transition is avoided.

Use of different DRX patent configurations such as long DRX, idle DRX, separate DRX and so forth pattern configurations for out-of-sync state can be used to optimize DRX for the unsynchronized state. For example, if traffic is bursty in nature and inter-burst arrival time is relatively long compared to the packet arrival time inside a burst, a normal DRX can be used to configure for intra-burst packet traffic while DRX for unsynchronised state can be configured by taking into account inter-burst characteristic. A device can move into the unsynchronised state between the bursts. By configuring DRX in this way, a device can transmit the packets with short delay inside burst while power can be saved and network can save uplink resources between the bursts

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

It is noted that whilst embodiments have been described in relation to LTE, similar principles can be applied to any other communication system or indeed to further developments with LTE. Also, instead of connectivity being provided by a base station this may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more of any of the other embodiments previously discussed.

1. A method for handling transition of a connected device to an unsynchronised state, comprising:
determining a trigger for move from a synchronised state,
releasing a control channel for the synchronised state, and
moving to the unsynchronised state while remaining connected based on a discontinuous reception configuration defined for the unsynchronised state.

2. A method for handling a device in an unsynchronised state, comprising:
sending to the device a discontinuous reception configuration to be used by a device when in the unsynchronised state while remaining connected, and
sending control information to the device according to the discontinuous reception configuration defined for the unsynchronised state.

3. A method as claimed in claim 1, wherein the move from synchronised state to unsynchronised state is triggered by determined expiry of a time alignment timer.

4. A method for handling transition to an unsynchronised state, comprising:
sending to a network a request for transition of a device from a synchronised state to the unsynchronised state,
receiving from the network a command to move to the unsynchronised state,
stopping a time alignment timer,
releasing a control channel for the synchronised state, and
remaining connected to the network based on a discontinuous reception configuration defined for the unsynchronised state.

5. A method for handling transition to an unsynchronised state, comprising:
receiving a request for transition of a device from a synchronised state to the unsynchronised state,
sending to the device a command to move to the unsynchronised state thereby causing the device to stop a time alignment timer and release a control channel for the synchronised state, and
maintaining the device in connected state based on a discontinuous reception configuration defined for the unsynchronised state.

6. A method as claimed in claim 1, comprising configuring the device based on radio resource control signalling or at least one broadcast message.

7. A method as claimed in claim 1, wherein the device performs at least one of a measurement, reporting and monitoring of a physical downlink control channel in accordance with the discontinuous reception configuration.

8. A method as claimed in claim 1, comprising using a long discontinuous reception pattern as a default reception pattern when the device is in the unsynchronised state.

9. A method as claimed in claim 1, comprising using an idle state discontinuous reception pattern as a default reception pattern when the device is in the unsynchronised state.

10. A method as claimed in claim 1, comprising communicating information from the device to the network before the device moves to the unsynchronised state, the information being indicative of a discontinuous reception pattern to be used by the device when in the unsynchronised state.

11. A method as claimed in claim 10, wherein the information indicates if a short or a long discontinuous reception pattern is to be used by the device.

12. A method as claimed in claim 1, comprising determining a time alignment timer expiry and releasing resources associated with a physical uplink control channel before ordinary expiry of the time alignment timer.

13. A method as claimed in claim 1, comprising:
determining that the device will be inactive for at least a period, and
in response to the determining, processing a request for a move of the device to the unsynchronised state.

14. A method as claimed in claim 1, comprising signalling at least one message regarding the move of the device to unsynchronised state based on media access control (MAC) protocol.

15. An apparatus comprising at least one processor, and at least one memory including computer program code, wherein the at least one memory and the computer program code are configured, with the at least one processor, to
determine a trigger for move from a synchronised state,
release a control channel for the synchronised state, and
move the device to an unsynchronised state while remaining connected based on a discontinuous reception configuration defined for the unsynchronised state.

16. An apparatus comprising at least one processor, and at least one memory including computer program code, wherein the at least one memory and the computer program code are configured, with the at least one processor, to
cause sending to a device a discontinuous reception configuration to be used when the device is in an unsynchronised state while remaining connected, and
cause sending of control information to the device according to the discontinuous reception configuration defined for the unsynchronised state.

17. An apparatus as claimed in claim 15, configured to cause move to the unsynchronised state and use of the defined discontinuous reception configuration subsequent to expiry of a time alignment timer.

18. An apparatus comprising at least one processor, and at least one memory including computer program code, wherein the at least one memory and the computer program code are configured, with the at least one processor, to:
cause sending to a network a request for transition of a device from a synchronised state to the unsynchronised state,
receive from the network a command to move to the unsynchronised state,
stop a time alignment timer,
release a control channel for the synchronised state, and
maintain the device connected to the network based on a discontinuous reception configuration defined for the unsynchronised state.

19. An apparatus comprising at least one processor, and at least one memory including computer program code, wherein the at least one memory and the computer program code are configured, with the at least one processor, to:
receive a request for transition of a device from a synchronised state to the unsynchronised state,
sending to the device a command to move to the unsynchronised state, thereby causing the device to stop a time alignment timer and release a control channel for the synchronised state, and
maintain the device in connected state based on a discontinuous reception configuration defined for the unsynchronised state.

20. An apparatus as claimed in claim 15, configured to cause configuration of the discontinuous reception pattern based on radio resource control signalling or at least one broadcast message.

21. An apparatus as claimed in claim 15, wherein at least one of a measurement, reporting and monitoring of a physical downlink control channel is provided in accordance with the discontinuous reception configuration.

22. An apparatus as claimed in claim 15, configured to use a long discontinuous reception pattern or an idle state discontinuous reception pattern as a default reception pattern in the unsynchronised state.

23. An apparatus as claimed in claim 15, configured to cause communications of information indicative of a discontinuous reception pattern to be used when the unsynchronised state is used.

24. An apparatus as claimed in claim 23, wherein the information indicates if a short or a long discontinuous reception pattern is to be used by the device.

25. An apparatus as claimed in claim 15, configured to determine a time alignment timer expiry and cause releasing of resources associated with a physical uplink control channel before ordinary expiry of the time alignment tinier.

26. An apparatus as claimed in claim 15, configured to
determine that the device will be inactive for at least a period, and
in response to the determining, process a request for a move of the device to the unsynchronised state.

27. An apparatus as claimed in claim 15, configured to signal at least one message regarding the move of the device to unsynchronised state based on media access control (MAC) protocol.

28. A communication device comprising apparatus in accordance with claim 15.

29. A mobile user equipment comprising a communication device in accordance with claim 28.

30. A network device comprising apparatus in accordance with claim 16.

31. A computer program comprising code means adapted to perform the steps of claim 1 when the program is run on processor apparatus.
